(19) United States
(12) Patent Application Publication
(10) Pub. No.: US 2019/0301394 A1
(43) Pub. Date: Oct. 3, 2019

(54) INTERNAL COMBUSTION ENGINE

(71) Applicant: AVL LIST GMBH, Graz (AT)

(72) Inventor: Christof Knollmayr, Graz (AT)

(21) Appl. No.: 16/308,097

(22) PCT Filed: Jun. 9, 2017
(86) PCT No.: PCT/AT2017/060148

§ 371 Date: Dec. 7, 2018

(30) Foreign Application Priority Data
Jun. 9, 2016 (AT) A 50528/2016

(51) Int. Cl. F02F 1/40; F01P 3/02

(52) U.S. Cl. CPC F02F 1/40; F02F 2001/104; F01P 3/02

(57) ABSTRACT

The invention relates to a fluid-cooled internal combustion engine (1) having at least one cylinder block (40) and at least one cylinder head (10) for at least two cylinders (41), wherein the internal combustion engine (1) has a first side (4) and an opposite second side (5) of a longitudinal center plane (27) spanned by at least two cylinder axes (46) of the cylinders (41). In at least one web portion (12) between two cylinders (41) positioned next to one another in the region of a motor transverse plane (3) arranged in a normal position to the longitudinal center plane in the cylinder head (10), at least one second cooling channel (13) connecting the first side (4) and the second side (5), having at least one first opening (31) on the first side (4) and at least one second opening (32) on the second side (5), is arranged. The aim of the invention is to cool the web portion (12) in a most space-saving manner. This aim is achieved in that between the first opening (31) and the second opening (32), the second cooling channel (13) is molded into the cylinder head as a closed cross section, and has, from a cylinder head sealing plane (11) of the cylinder head (10), at least in the region of the longitudinal center plane (27) in the direction of a cylinder axis (46), a sealing plane distance (a).

The invention relates to an internal combustion engine with liquid cooling, comprising at least one cylinder block and at least one cylinder head for at least two cylinders, wherein the internal combustion engine has a first side and an opposite second side of a longitudinal center plane spanned by at least two cylinder axes of the cylinder, and at least one second cooling channel, which connects the first side and the second side and has at least one first opening on the first side and at least one second opening on the second side, is arranged in at least one web region between two adjacently disposed cylinders in the region of an engine transverse plane in the cylinder head which is arranged perpendicular to the longitudinal center plane.

In order to achieve sufficient cooling of the internal combustion engine, cooling channels are provided in the engine block. However, since there can also be a problem with heat dissipation in the area of the cylinder head between two adjacent cylinders in high-performance engines, sufficient cooling must also be provided in the cylinder head.

It is known to produce cooling channels by saw cuts from the cylinder head sealing plane.

Cylinder blocks with such cooling channels in the cylinder head are known from DE 10 2005 033 338 A1. However, the cooling channel is formed as a groove, i.e. as an open cross-sectional shape in the area of the cylinder head sealing plane, and produced by sawing or milling. The disadvantage of this embodiment is the space required for this cooling groove and the resulting more elaborately designed cylinder head gasket. Furthermore, this results in a longer engine length, which is disadvantageous with regard to the increasing packaging problems in engine development today.

It is therefore the object of the invention to provide a possibility for engine cooling in the area of the cylinder head that is compact and simple to design and does not increase the required engine length.

This object is achieved in accordance with the invention in that the second cooling channel is formed between the first and the second opening as a closed cross-section into the cylinder head and has a sealing plane distance from a cylinder head sealing plane of the cylinder head at least in the region of the longitudinal center plane in the direction of a cylinder of the axis. This enables a cylinder head to be cooled in areas subject to high thermal loads, thus saving space in the area of the cylinder head gasket. As a result, cylinder head cooling is achieved at a constant engine length. In addition, it can also be used for cooling in areas that have a greater distance from the cylinder head sealing plane and thus positively influence the knocking tendency of the engine.

Closed cross-sections can be formed into the cylinder head by drilling, casting or spark erosion, for example.

A further advantage arises if at least one of the two openings is arranged in the area of the fire deck, as this makes production as simple as possible, since a bore hole can be drilled from the fire deck.

An advantageous embodiment variant is obtained if—as measured in the area of the longitudinal center plane in the direction of the cylinder axis—the sealing plane distance between the second cooling channel and the cylinder head sealing plane corresponds to at least one smallest wall thickness of a fire deck of the cylinder head in the area of a combustion chamber. This ensures that the space saving can really be achieved without the wall thicknesses becoming too small to guarantee mechanical strength.

It is advantageous if the second cooling channel is formed in an ascending manner at least in sections from an area of the fire deck of the cylinder head, preferably from the cylinder head sealing plane in the direction of the longitudinal center plane, as the engine length is then relatively slightly longer or of the same length compared with a version without cooling channels in the cylinder head.

Simple manufacture by drilling is possible if the second cooling channel has at least a first partial channel and at least a second partial channel, wherein the first partial channel extends in an ascending manner on the first side starting from the first opening in a region of the fire deck of the cylinder head, preferably from the cylinder head sealing plane in the direction of the longitudinal center plane, and the second partial channel extends on the second side starting from the second opening in a region of the fire deck of the cylinder head, preferably from the cylinder head sealing plane in the direction of the longitudinal center plane.

In order to ensure a flow connection between the partial channels of a second cooling channel, it is advantageous if the first partial channel and the second partial channel are connected to each other—preferably in the region of the longitudinal center plane—in the region of an intersection point of the partial channel axes, wherein the intersection point is preferably distanced by the sealing plane distance from the cylinder head sealing plane.

The intersection point may also be located outside the longitudinal center plane.

For optimum cooling of the cylinder head, it may be provided in a preferred embodiment of the invention that the first partial channel is formed to extend from the first opening to a second partial cooling space of the cylinder head arranged substantially on the second side and/or that the second partial channel is formed to extend from the second opening to a first partial cooling space of the cylinder head arranged substantially on the first side.

In order to increase the cooling surface, it is advantageous if a third partial channel is provided between the first partial channel and the second partial channel, which preferably runs parallel to the cylinder head sealing plane.

A particularly advantageous embodiment variant is obtained if the first opening opens into a first partial cooling jacket space of the cylinder block arranged on the first side and/or that the second opening opens into a second partial cooling jacket space of the cylinder block arranged on the second side.

The term cooling jacket space here refers to any spatial recess for cooling purposes in the cylinder block and the term cooling space refers to any spatial recess for the same purpose in the cylinder head. Common spaces in the cylinder head and cylinder block are separated by the cylinder head sealing plane into the cooling space and the cooling jacket space.

The advantage of any design of the second cooling channel arises if at least one second cooling channel is formed in the cylinder head by bores or by forming in a casting process or by spark erosion. In the case of bores, production is particularly simple and inexpensive; in the case of spark erosion, the cooling channels can also have more complex cross-sectional shapes, such as a triangular shape for example, and virtually any cooling channel shape can be formed by casting, for example by salt cores. In the following, the invention is explained in more detail on the basis of the explanations given in the non-restrictive figures, wherein:

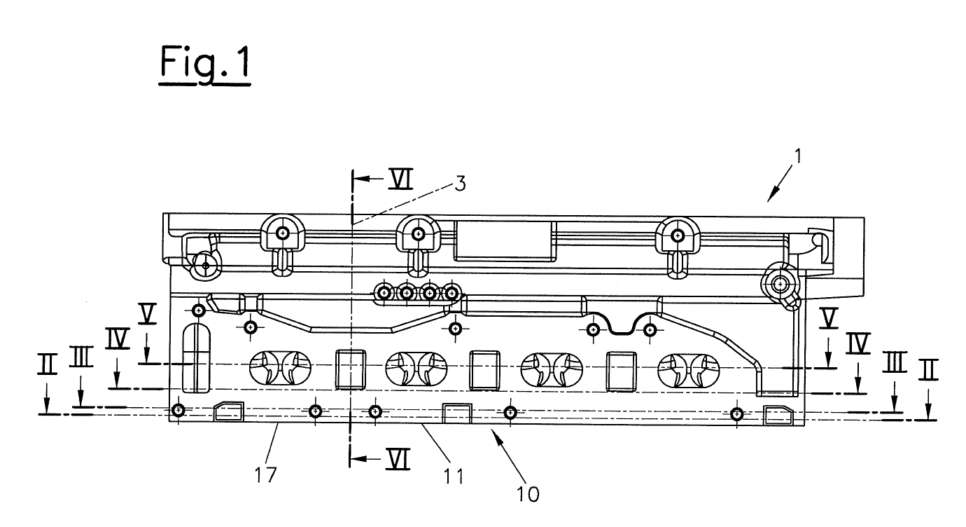

FIG. 1 shows the cylinder head according to the invention in a view from a long side;

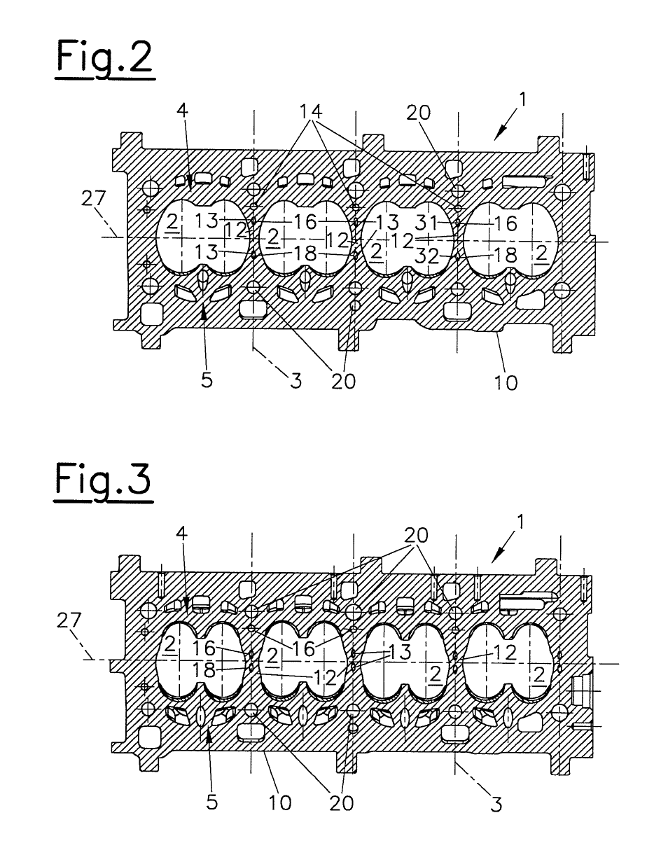

FIG. 2 shows a first embodiment of the cylinder head according to the invention in a section according to line II-II in FIG. 1;

FIG. 3 shows this first embodiment of the cylinder head in a section according to line III-III in FIG. 1;

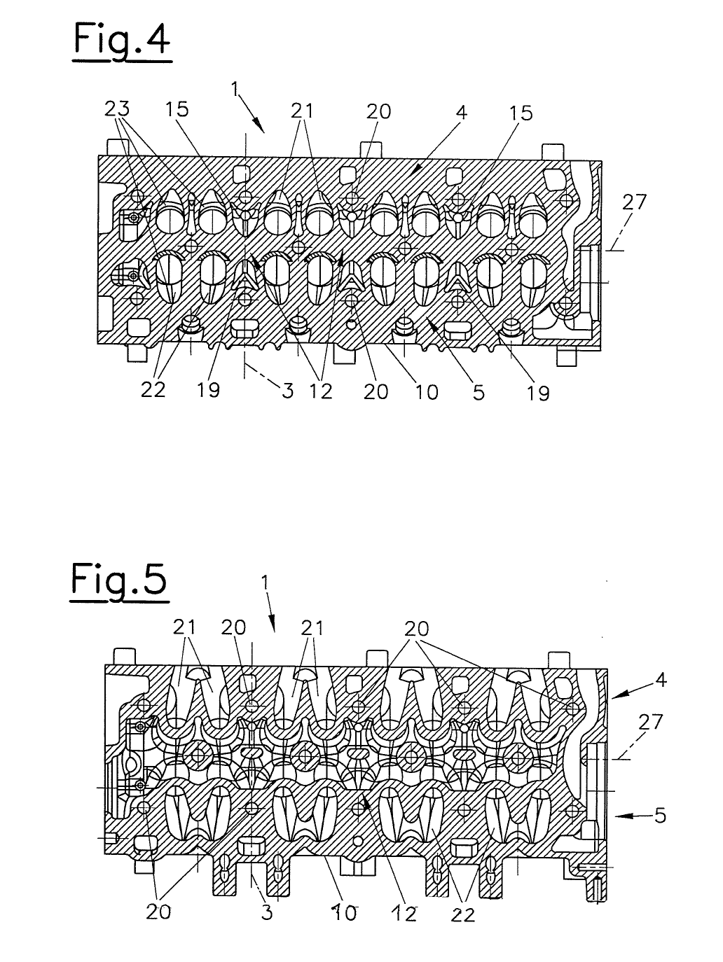

FIG. 4 shows the first embodiment of the cylinder head in a section according to the line IV-IV in FIG. 1;

FIG. 5 shows the first embodiment of the cylinder head in a section according to the line V-V in FIG. 1;

FIG. 6 shows the first embodiment of the cylinder head in a section according to the line VI-VI in FIG. 1;

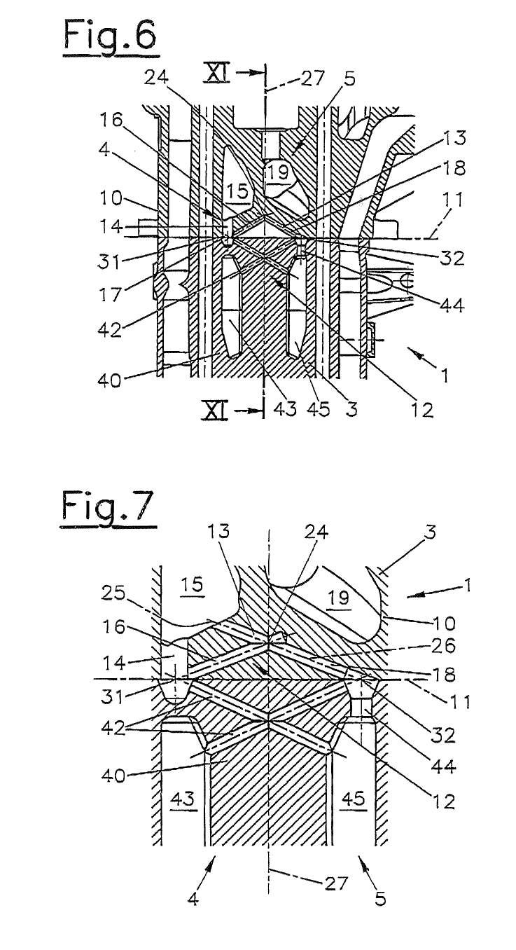

FIG. 7 shows a second embodiment of the cylinder head according to the invention in a section analogous to FIG. 6;

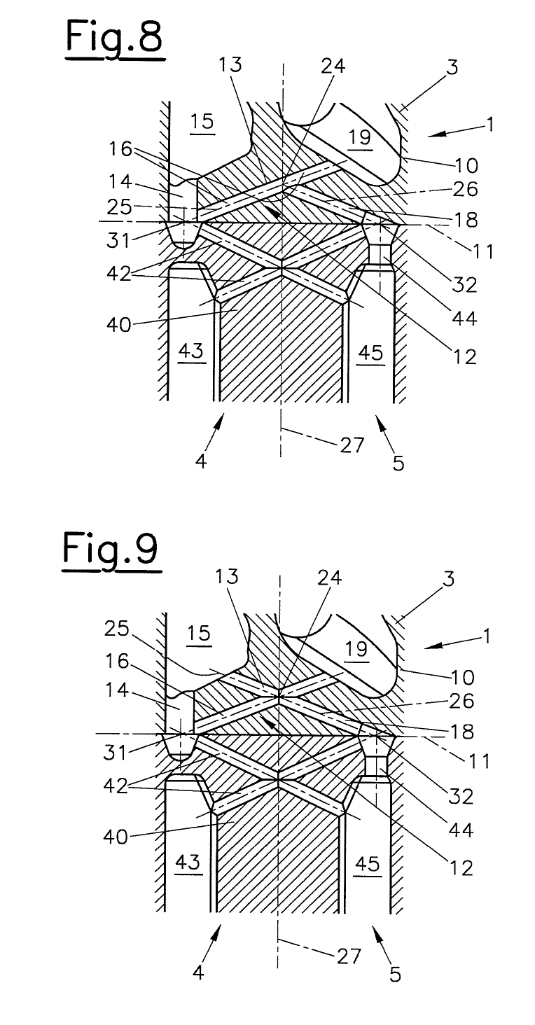

FIG. 8 shows a third embodiment of the cylinder head according to the invention in a section analogous to FIG. 6;

FIG. 9 shows a fourth embodiment of the cylinder head according to the invention in a section analogous to FIG. 6;

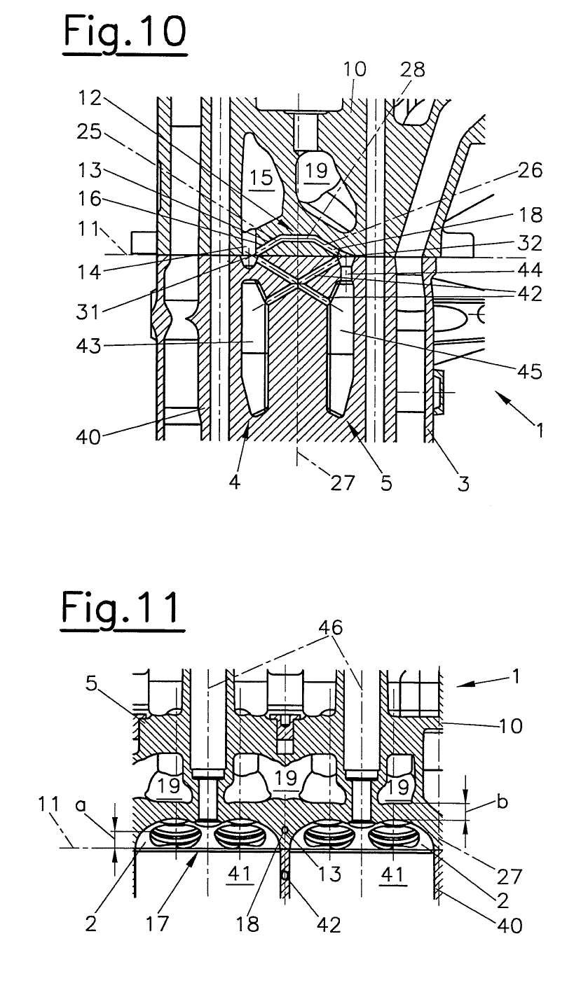

FIG. 10 shows a fifth embodiment of the cylinder head according to the invention in a section analogous to FIG. 6; and

FIG. 11 shows the first embodiment of the cylinder head in a section according to the line XI-XI in FIG. 6.

As shown in FIG. 1, an internal combustion engine 1 according to the invention has a cylinder head 10 with an assigned cylinder head sealing plane 11. This cylinder head sealing plane 11 forms the contact surface between cylinder head 10 and a cylinder block 40. The fire deck 17 adjoins the cylinder head sealing plane 11 on the side of the cylinder head. In the illustrated embodiment, the cylinder block 40 has four cylinders 41, some of which are shown in FIG. 11.

In FIG. 2, the cylinder head 10 is shown in a first embodiment in a section along the line II-II in FIG. 1, with four combustion chambers 2 each assigned to one of the cylinders 41. A longitudinal center plane 27 is spanned by at least two cylinder axes 46 (see FIG. 11) of the cylinder 41; in the illustration in FIG. 2 the longitudinal center plane 27 runs vertically to the sheet plane. The internal combustion engine 1 and thus also cylinder head 10 and cylinder block 40 have a first side 4 and a second side 5 which represent the opposite sides of the longitudinal center plane 27.

A web region 12 can be seen between each two combustion chambers 2 each. A second cooling channel 13 is located in this web region 12 in the area of an engine transverse plane 3 arranged normal to the longitudinal center plane 27. Starting from a first partial cooling jacket space 43 in the cylinder block 40, a first riser 14 of a first partial cooling space 15 of the cylinder head 10 is located in the cylinder head 10.

In relation to the longitudinal center plane 27 spanned by the cylinder axes 46 of the cylinders 41, the second cooling channel 13 starts in a first partial channel 16 in a first opening 31 from a first side 4 of a fire deck 17 and is flow-connected to the first riser 14 on this first side 4.

The flow connection between the first partial channel 16 and a second riser 44, which is arranged on the second side 5, of a second partial cooling jacket space 45 of the cylinder block 40 is established by a second partial channel 18, which also starts in a second opening 32 from the fire deck 17.

Fire deck 17 is located in the area of cylinder head sealing plane 11 and includes all freely accessible surfaces of cylinder head 10 from the cylinder head sealing plane 11.

From FIG. 3 it can be seen by comparison with FIG. 2 that the second cooling channel 13 consists of two partial channels 16, 18, which approach each other more and more the further they move—in the direction of a cylinder axis 46 (i.e. from the sheet plane in FIG. 3)—away from the fire deck 17.

The first partial cooling space 15 and a second partial cooling space 19 are shaped in the illustrated embodiment in such a way that they partly lead around bores 20 for cylinder head screws (not shown), as shown in FIG. 4.

Each cylinder 41 is assigned two first gas channels 21, for example inlet channels, and two second gas channels 22, for example outlet channels. Between said channels and combustion chamber 2 there are the gas exchange valves (not shown), whose valve seats 23 can be seen in FIG. 4.

The first side 4 and second side 5 of the internal combustion engine 1 designate the intake side and the exhaust side in the present exemplary embodiments. The first partial cooling space 15, the first riser 14 and the first gas channel 21, as well as the first partial cooling jacket space 43 are located on the first side 4 of the internal combustion engine 1. The second partial cooling space 19, the second gas channel 22, the second riser 44 and the second partial cooling jacket space 45 are located on the second side 5 of the internal combustion engine 1.

In accordance with the invention, additional cooling channels are now provided in the web regions 12 between the cylinders 41. A first embodiment of the second cooling channel 13 can be seen in FIG. 6. In this case, the first partial channel 16 and the second partial channel 18 intersect each other and in this embodiment the partial channels 16, 18 end immediately after an intersection point 24 of a first partial channel axis 25 and a second partial channel axis 26. The partial channels 16 and 18 are designed as bores which start from the fire deck 17. The resulting shape of the second cooling channel 13 represents an inverted V, the tip of which is located in the area of the longitudinal center plane 27 between the first partial cooling space 15 and the second partial cooling space 19.

In the longitudinal center plane 27 formed by the cylinder axes 46, a distance, i.e. the sealing plane distance a, is defined which is measured from the cylinder head sealing plane 11 to the second cooling channel 13. This sealing plane a is larger than the smallest wall thickness b of the fire deck 17 measured in the area of combustion chamber 2 (FIG. 11).

The cylinder block 40 contains the first cooling channel 42, which in the illustrated embodiment extends X-shaped between the first partial cooling jacket space 43 and the second partial cooling jacket space 45.

FIG. 7 shows a second embodiment in which the second partial channel 18 crosses the first partial channel 16 and continues to the first partial cooling space 15. The second cooling channel here is Y-shaped, with the open side of the “Y” pointing in the direction of the cylinder head sealing plane 11.

In a third embodiment, as shown in FIG. 8, the first partial channel 16 is continued to the second partial cooling space 19 and the second cooling channel also extends Y-shaped.

As shown in FIG. 9, the second cooling channel 13 is X-shaped in a fourth embodiment. The second riser 44 of the second partial cooling jacket space 45 is connected to the first partial cooling space 15 and the first riser 14 of the first partial cooling space 15 is connected to the second partial cooling space 19.

FIG. 10 shows a fifth embodiment. In addition to the two partial channels 16, 18 of the second cooling channel 13, a third partial channel 28 is available. In the illustrated embodiment, this third partial channel 28 runs parallel to cylinder head sealing plane 11.

In an embodiment variant not shown, it is possible for the third partial channel 28 to extend in an inclined manner at an angle to the cylinder head sealing plane 11, thus connecting the first partial channel 16 and the second partial channel 18 of the second cooling channel 13 to each other in terms of flow.

The third partial channel 28 allows a not too shallow angle of attack for a drilling tool when producing partial channels 16, 18 for large distances between inlet side and outlet side. The third partial channel 28 can be formed by lost cores in a casting process or by a bore. If the third partial channel 28 is formed by a bore, the undesired flow connection to the outside is prevented by closures that are not shown further. The second cooling channel 13 can, for example, be formed by spark erosion.

While the cooling channels in the illustrated embodiments essentially extend in or parallel to engine transverse plane 3, variants are also possible in which the channels run in the web region 12 inclined to the engine transverse plane.

1. An internal combustion engine with liquid cooling, comprising:
at least one cylinder block and at least one cylinder head for at least two cylinders,
a first side and an opposite second side of a longitudinal center plane which is spanned by at least two cylinder axes of the cylinders and at least one second cooling channel,
the at least one second cooling channel connects the first side and the second side and has at least one first opening on the first side and at least one second opening on the second side, and the at least one second cooling channel is arranged in at least one web region between two adjacently disposed cylinders in the region of an engine transverse plane in the cylinder head.
the at least one cylinder head arranged perpendicular to the longitudinal center plane, the second cooling channel is formed into the cylinder head as a closed cross-section between the first opening and the second opening.

2. The internal combustion engine of claim 1, characterized in that at least one of the two openings is arranged in the region of a fire deck.

3. The internal combustion engine of claim 1, characterized in that a sealing plane distance between the second cooling channel and the cylinder head sealing plane, at least in the region of the longitudinal center plane and in the direction of a cylinder axis, corresponds to at least one smallest wall thickness of a fire deck of the cylinder head in the region of a combustion chamber.

4. The internal combustion engine of claim 3, characterized in that the second cooling channel ascends at least in sections from a region of the fire deck of the cylinder head.

5. The internal combustion engine of claim 3, characterized in that the second cooling channel includes at least a first partial channel and at least a second partial channel, wherein the first partial channel extends in an ascending manner on the first side starting from the first opening in a region of the fire deck of the cylinder head, and the second partial channel extends on the second side starting from the second opening in a region of the fire deck of the cylinder head.

6. The internal combustion engine of claim 5, characterized in that the first partial channel and the second partial channel are connected to one another in the region of an intersection point of the partial channel axes.

7. The internal combustion engine of claim 5, characterized in that the first partial channel is configured and arranged to extend from the first opening to a second partial cooling space of the cylinder head arranged essentially on the second side and/or that the second partial channel is designed to extend from the second opening to a first partial cooling space of the cylinder head arranged essentially on the first side.

8. The internal combustion engine of claim 5, wherein the second cooling channel further includes a third partial channel that is provided between the first partial channel and the second partial channel.

9. The internal combustion engine of claim 1, characterized in that the first opening opens into a first partial cooling jacket space, arranged on the first side of the cylinder block.

10. The internal combustion engine of claim 1, characterized in that at least one second cooling channel is formed in the cylinder head by bores or by forming in a casting process or by spark erosion.

11. The internal combustion engine of claim 1, wherein the second opening opens into a second partial cooling jacket space, arranged on the second side of the cylinder block.

12. The internal combustion engine of claim 9, wherein the second opening opens into a second partial cooling jacket space, arranged on the second side of the cylinder block.

13. The internal combustion engine of claim 6, wherein the first and second partial channels are connected to one another in the region of the longitudinal center plane.

14. The internal combustion engine of claim 6, wherein the intersection point of the partial channel axes is the sealing plane distance from the cylinder head sealing plane.

15. The internal combustion engine of claim 5, wherein the first partial channel extends from the cylinder head sealing plane in the direction of the longitudinal center plane.

16. The internal combustion engine of claim 5, wherein the second partial channel extends from the cylinder head sealing plane in the direction of the longitudinal center plane.

17. The internal combustion engine of claim 4, wherein the second cooling channel ascends from the cylinder head sealing plane in the direction of the longitudinal center plane.
